(19) United States
(12) Patent Application Publication
(10) Pub. No.: US 2026/0100887 A1
(43) Pub. Date: Apr. 9, 2026

(54) MULTI-LANGUAGE MODEL-BASED FILTERING AND LABELING OF DATASETS

(71) Applicant: Cisco Technology, Inc., San Jose, CA (US)

(72) Inventor: Akram Sheriff, Newark, CA (US)

(73) Assignee: Cisco Technology, Inc., San Jose, CA (US)

(21) Appl. No.: 19/281,937

(22) Filed: Jul. 28, 2025

Related U.S. Application Data
(60) Provisional application No. 63/702,715, filed on Oct. 3, 2024.

(51) Int. Cl. H04L 41/149; G06N 20/20

(52) U.S. Cl. CPC H04L 41/149; G06N 20/20

(57) ABSTRACT

In various implementations, a device makes a first prediction regarding telemetry data from an entity in a computer network using one or more N-gram models. The device also makes a second prediction regarding the telemetry data using one or more large language models. The device applies a label to the telemetry data based on the first prediction and on the second prediction. The device provides the label to train a predictive maintenance model for the entity in the computer network.

### RELATED APPLICATION

This application claims priority to U.S. Provisional Application No. 63/702,715, filed Oct. 3, 2024, entitled “MULTI-LANGUAGE MODEL-BASED FILTERING AND LABELING OF DATASETS” by Sheriff, et al., the contents of which are incorporated herein by reference.

### TECHNICAL FIELD

The present disclosure relates generally to computer networks, and, more particularly, to multi-language model-based filtering and labeling of datasets.

### BACKGROUND

Large volumes of telemetry data are generated by devices in modern networking environments for purposes of monitoring the health, status, and operational events of the networks and their constituent components. This telemetry data can include system logs, performance metrics, event traces, and other diagnostic information captured from devices in real-time. From this information, along with potentially other multi-modal data such as audio signals, video feeds, etc., a network operator may infer whether a given networking device requires maintenance.

However, certain types of events may be completely benign or indicative of a device needing immediate remediation. For instance, a device reset event may be attributable to a software update or may be caused by the device running out of resources. Today, this often requires a human expert to assess the telemetry data and discern the underlying cause of the event.

While it may be possible to use machine learning/artificial intelligence to perform this analysis, doing so would require a labeled training dataset this is sufficiently large and robust to cover all possible scenarios in the captured telemetry data. Asking a human expert to provide this labeling may also be too time consuming and infeasible from a time perspective. In addition, human error during the labeling process could lead to poor model performance.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of a user interfacing with a generative model;

FIG. 4 illustrates an example architecture for an artificial intelligence (AI) agent;

FIG. 5 illustrates an example of a data labeling training pipeline for multi-language model-based filtering and labeling of datasets;

FIG. 6 illustrates an example of a data quality filter output;

FIG. 7 illustrates an example of an automated labeling output from a data labeling and training pipeline;

FIG. 8 illustrates an example of a labeling review interface;

FIG. 9 illustrates and example of a prediction pipeline for multi-language model-based filtering and labeling of datasets; and

FIG. 10 illustrates an example procedure for multi-language model-based filtering and labeling of datasets, in accordance with one or more implementations described herein.

### DESCRIPTION OF EXAMPLE IMPLEMENTATIONS

### Overview

According to one or more implementations of the disclosure, a device makes a first prediction regarding telemetry data from an entity in a computer network using one or more N-gram models. The device also makes a second prediction regarding the telemetry data using one or more large language models. The device applies a label to the telemetry data based on the first prediction and on the second prediction. The device provides the label to train a predictive maintenance model for the entity in the computer network.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

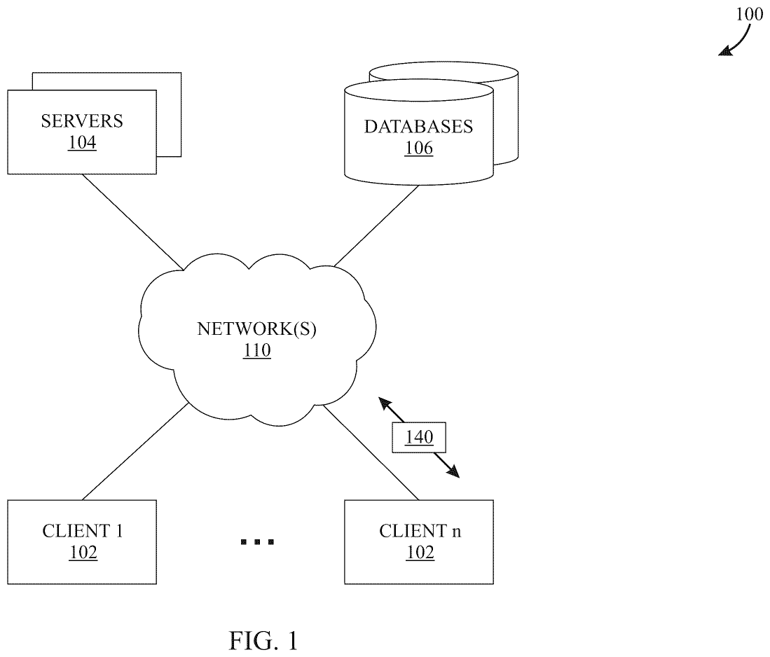

FIG. 1 is a schematic block diagram of an example simplified computing system (e.g., computing system 100) illustratively comprising any number of client devices (e.g., client devices 102 (e.g., a first through nth client device), one or more servers (e.g., servers 104), and one or more databases (e.g., databases 106), where the devices may be in communication with one another via any number of networks (e.g., network(s) 110).

The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc.

The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

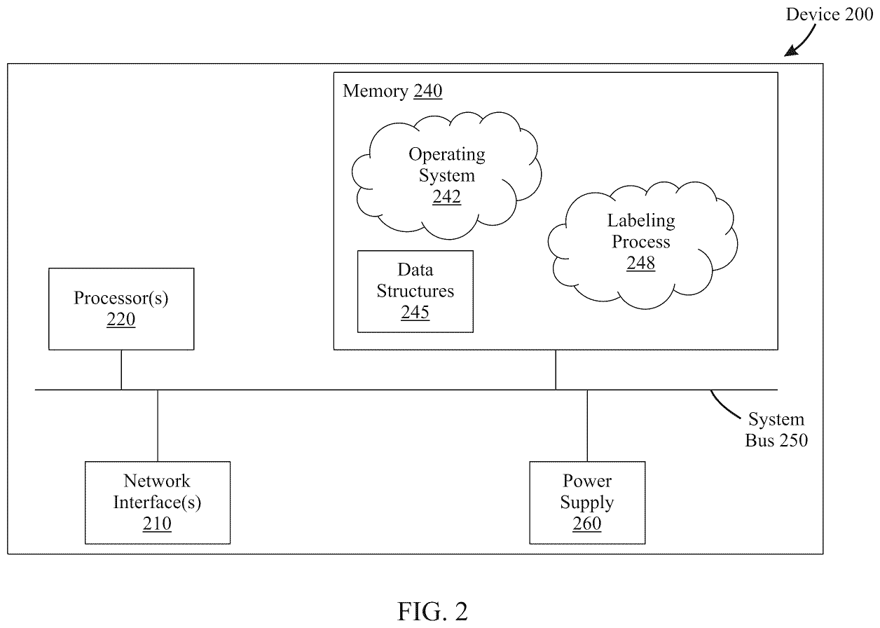

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processes and/or services executing on the device. These software processes and/or services may comprise one or more functional processes, and on certain devices, a labeling process 248, as described herein. Notably, the functional processes, when executed by processor(s) 220, may cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, labeling process 248 may include computer executable instructions that, when executed by processor(s) 220, cause device 200 to perform the techniques described herein. For example, labeling process 248 may include computer-executable instructions stored on a computer-readable medium that are executable by processor(s) 220 to cause node/device 200 to perform a portion of operations associated with the detection and mitigation of note injection across persistent language model sessions.

To do so, in some implementations, labeling process 248 may utilize and/or be part of a machine learning system. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, labeling process 248 may use one or more supervised, unsupervised, or semi-supervised machine learning models. Generally, supervised learning entails the use of a training set of data, as noted above, that is used to train the model to apply labels to the input data. For example, the training data may include sample telemetry or other data that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the labeling process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, labeling process 248 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of persistent machine learning models, labeling process 248 may use a generative model to label datasets coming from networking devices regarding their reset reasons (and other string data) to support the use of a multi-modal data large language model (MM-LLM) which leverages datasets such as logs, text, video, voice, other audio, and the like. Example generative approaches can include, but are not limited to, generative adversarial networks (GANs), N-gram and other predictive language models, foundation models such as large language models (LLMs), other transformer models, and the like.

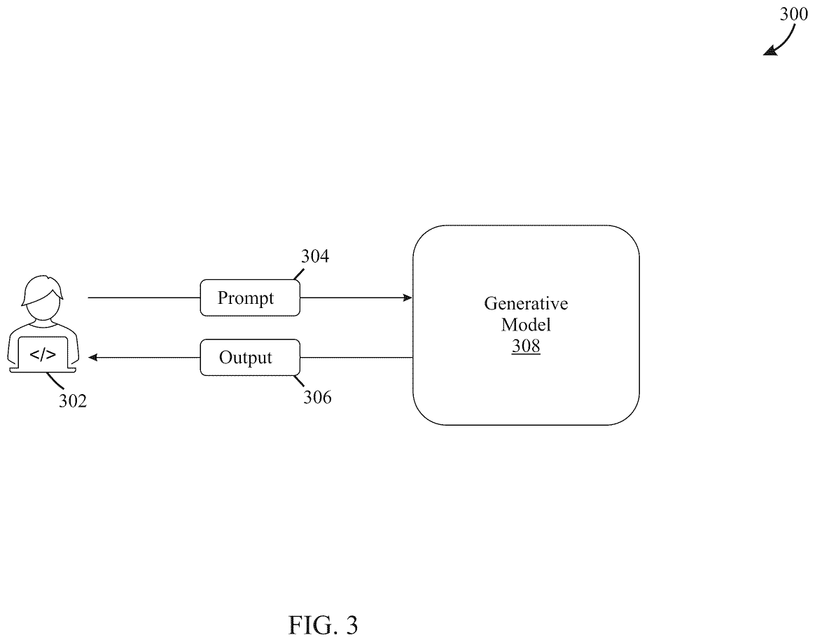

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

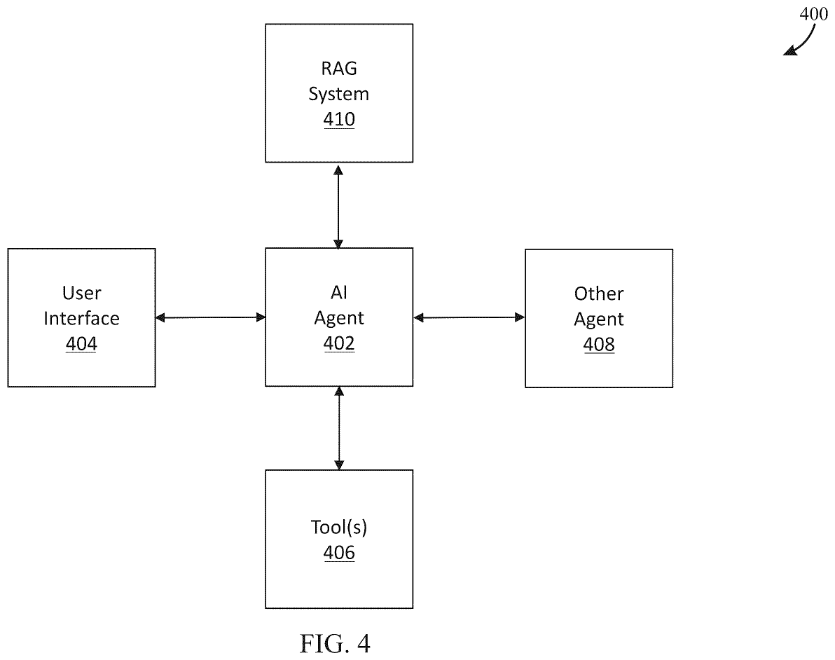

FIG. 4 illustrates an example architecture 400 for an artificial intelligence (AI) agent, according to various implementations. At the core of architecture 400 is AI agent 402, which may leverage one or more AI models to perform its tasks.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, large volumes of telemetry data are generated by devices in modern networking environments for purposes of monitoring the health, status, and operational events of the networks and their constituent components. This telemetry data can include system logs, performance metrics, event traces, and other diagnostic information captured from devices in real-time. Among this data, device reset logs may play a central role in identifying reasons for system failures, maintenance needs, and potential performance issues. These logs, alongside other multi-modal data such as text-based logs, audio signals, video feeds, etc. may be leveraged to predict maintenance needs and ensure reliable network operation.

It's critical that the datasets coming from the network devices regarding their reset conditions (and other sting data) are labeled in an efficient and accurate manner. This is particularly true to support the use of a multi-modal data large language model (MM-LLM) which leverages datasets such as logs, text, video, voice, other audio, and the like. Currently, the labeling of these datasets (e.g., often thousands or more of data samples/points for comparison) is performed manually by domain experts by interpreting individual data logs/inputs.

However, the limitations associated with this manual process render it insufficient to accomplish this labeling at scale. For instance, limited availability of domain experts and resources as well as the time-intensive nature of labeling results in bottlenecks, causing delays in model updates and increasing the likelihood of missing or incomplete labels. Resource turnover and onboarding as well as a rather steep learning curve for labeling such technical data can further contribute to these deficiencies. Furthermore, infrequent labeling schedules (e.g., model building is needed daily/weekly, but labeling is less frequent (e.g. quarterly)) can contribute to missing data and poor accuracy for downstream models.

Human error can also contribute to mislabeled data or misinterpreted logs, thereby degrading efficiency. Further, when labeling large volumes of information, bulk and misrepresented labels are often introduced, leading to degraded model accuracy and poor customer experience. In some cases, poot-quality labeling data and/or telemetry data (e.g., incomplete or corrupted entries) may further complicate the process and necessitate manual filtering (i.e. “%\hat{ }&\hat{ }$*($ #%%$%\hat{ }” is not a reset reason), which can reduce overall reliability and/or efficiency. These factors and many others associated with the current data labeling regime contribute to reduced model performance, resulting in suboptimal maintenance predictions, delayed interventions, and degraded customer experiences.

### Multi-Language Model-Based Filtering and Labeling of Datasets

In contrast, the techniques herein introduce a mechanism for multi-language model-based filtering and labeling of datasets. Here, an automated mechanism is provided for the labeling of telemetry data from networking devices, such as to label the reasons for device resets. The mechanism may be configured to implement an end-to-end labeling process that minimizes human resource utilization, to leverage an ensemble of language models to create labeled data, and/or to perform data quality-based filtering. The labeling output may be leveraged as a component of a predictive maintenance system.

Illustratively, the techniques described herein may be performed by hardware, software, and/or firmware, such as in accordance with labeling process 248, which may include computer executable instructions executed by the processor(s) 220 (or independent processor of the network interfaces 210) to perform functions relating to the techniques described herein.

Specifically, according to various implementations, a device makes a first prediction regarding telemetry data from an entity in a computer network using one or more N-gram models. The device also makes a second prediction regarding the telemetry data using one or more large language models. The device applies a label to the telemetry data based on the first prediction and on the second prediction. The device provides the label to train a predictive maintenance model for the entity in the computer network.

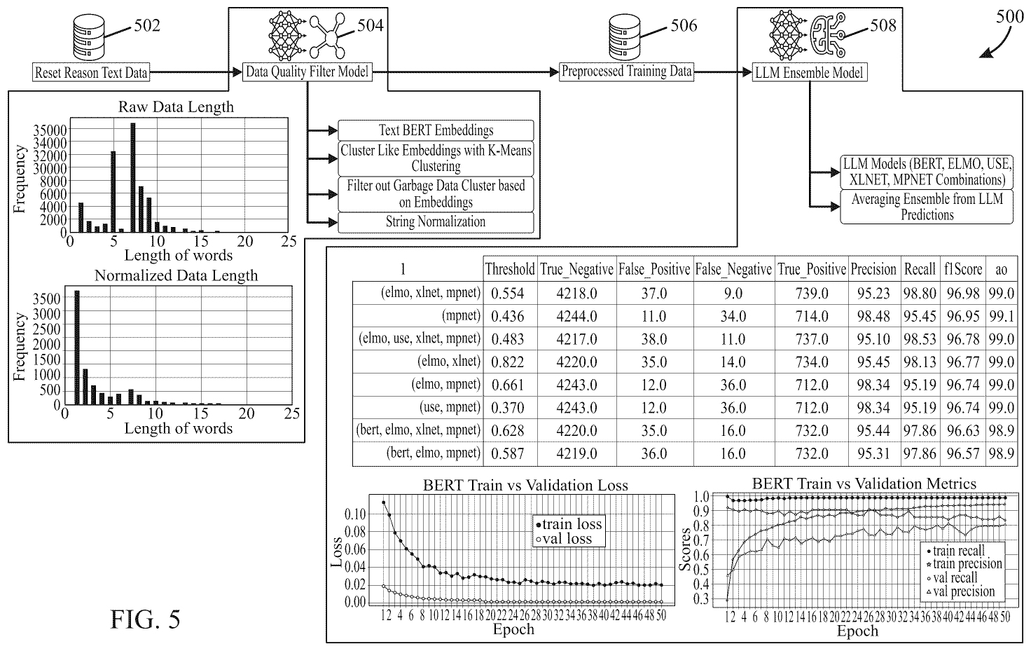

Operationally, FIG. 5 illustrates an example of a data labeling training pipeline 500 for multi-language model-based filtering and labeling of datasets, in accordance with one or more implementations described herein. Data labeling training pipeline 500 may be utilized to label the telemetry log data 502. As discussed above, networking device may send the telemetry log data 502 to language models. For instance, this data may be sent via an API endpoint (e.g., OpenAI Azure-API endpoint), which may be managed as a tenant by an enterprise generative AI management platform (e.g., motific.ai platform). For example, an IT service's tenant may be managed by such a generative AI platform.

The telemetry log data 502 may include system logs and/or telemetry data. For example, the telemetry log data 502 may include reset reason data. The reset reason data may include textual and/or other information generated by a device or system in a network when it undergoes and/or diagnoses a reset (i.e., restarts, reboots, resets itself due to an error, issue, or condition). This data may include an explanation about why the reset occurred. For example, it may indicate whether the reset was due to a software crash, a hardware failure, power loss, memory corruption, or a manual intervention by a user or system administrator.

The telemetry log data 502 may then be processed through a data quality filter 504. The data quality filter 504 may be a model such as a machine learning or rule-based system designed to identify and remove low-quality, irrelevant, or erroneous data from a data set. In the context of text data, it may ensure that only meaningful, useful, and/or accurate information is retained for analysis or further processing. The data quality filter 504 may be operable to ensure and enhance the quality of inputs for downstream tasks like model labeling and/or training. For instance, the data quality filter 504 may identify missing or corrupted data, detect anomalies or outliers, remove noise or garbage data such as meaningless text strings that do not contribute to the task at hand (e.g., logs with random characters like “%\hat{ }&\hat{ }$*($#%%$%\hat{ }” which does not constitute a valid reset reason), etc.

The data quality filter 504 may include and/or utilize a natural language processing model. For instance, the data quality filter 504 may include and/or utilize a bidirectional encoder representations from transformers (BERT) pre-trained natural language processing model that, among other things, can convert text into embeddings - dense vector representations that capture the meaning and context of the words or sentences. That is, the model may learn contextual relationships, so that each word in the telemetry log data 502 is represented in a context that contributes to its understanding beyond simple word matching and convert the text data into numerical representations of the semantic meaning of the text allowing the model to understand the text in a high-dimensional space and compare or cluster similar texts based on meaning.

The data quality filter 504 may utilize the natural language processing model to perform an unsupervised machine learning operation to group similar data points into clusters (e.g., K-means clustering). This may allow the organization of similar types of reset reasons or log entries together based on the meaning captured in their embeddings, rather than just matching words.

After clustering the like embeddings, the data quality filter 504 may utilize the natural language processing model to filter out garbage data clusters based on the embeddings. For example, data quality filter 504 may examine clusters to identify which ones are “garbage” (e.g., irrelevant, or meaningless). For example, a cluster may contain embeddings for text that is nonsensical or doesn't contribute to useful information. By identifying such clusters, the model can filter out the garbage automatically. This cleaning step may ensure that only cluster with valid, meaningful information are retained for further analysis or model training.

Data quality filter 504 may perform string normalization. This may include converting the text of data resulting from the filtering into a consistent format to reduce variability.

Once the data quality filter 504 has processed and filtered the telemetry log data 502, the cleaned and/or high-quality dataset may be considered preprocessed training data 506. Preprocessed training data 506 may be fed to an ensemble model 508 for further analysis, labeling, and/or model training. This preprocessed training data 506 may comprise only the meaningful, high-quality data from the telemetry log data 502.

The ensemble model 508 may be an ensemble of multiple individual models (e.g., language models such as LLMs) whose outputs can be combined to make more accurate predictions than a single model alone. For example, the ensemble model 508 may include combinations of language models such as BERT, embeddings from language models (ELMO), universal sentence encoder (USE) XLNET, MPNET, etc. The language models may be pretrained language models that have different strengths and architectures. By combining the outputs of these models, the ensemble model 508 may leverage each of their strengths.

Each of the language models of the ensemble model 508 may process the same preprocessed data independently, generating its own predictions based on its specific architecture and strengths. For instance, BERT might be better at handling short sentence context, while USE might be better at encoding whole sentences or documents. Once all the constituent models participating in the ensemble model 508 have made their predictions, the results from this ensemble of models may be combined. For instance, the combined predictions for the ensemble of models may be an average of the predictions of each of the models and/or may be based on more sophisticated techniques like weighted averages and the like to produce a final prediction that leverages the strengths of each individual model of the ensemble of models.

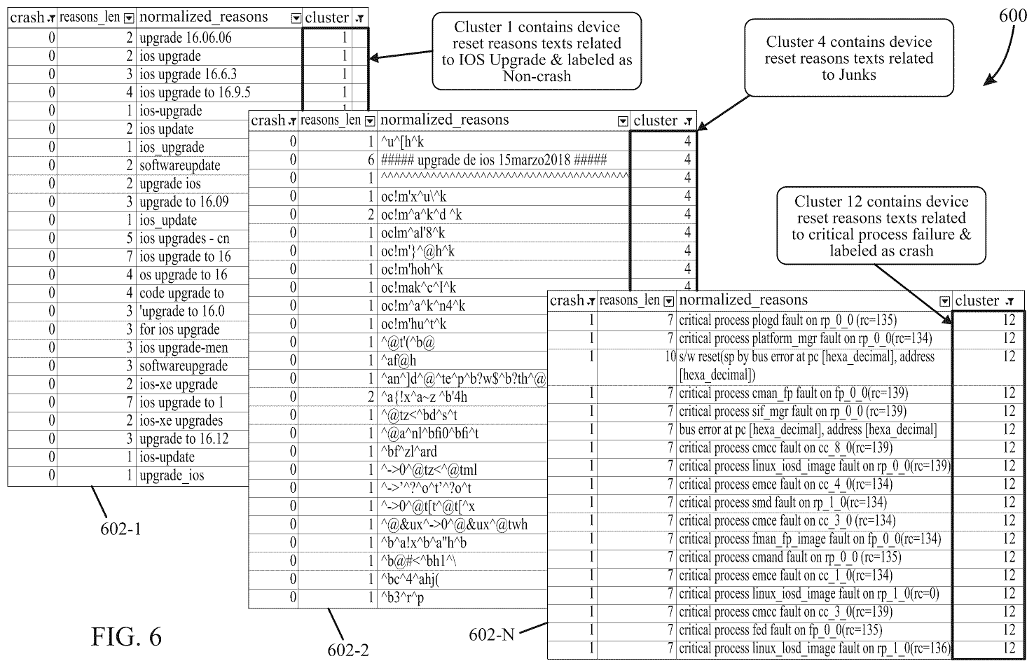

FIG. 6 illustrates an example of a data quality filter output 600, in accordance with one or more implementations described herein. Data quality filter output 600 may be an output of data quality filtering operations by a data quality filter (such as data quality filter 504 of FIG. 5). Data quality filter output 600 may include data clusters 602 of similar embeddings from the telemetry log data, as determined by the data quality filter model.

For example, a first data cluster 602-1 may be a cluster of telemetry log data that contains device reset responses texts related to IOS upgrades and may be labeled as non-crash. A second data cluster 602-2 may be a cluster of telemetry log data that contains device reset responses texts related to junk or garbage data. A third data cluster 602-N may be a cluster of telemetry log data that contains device reset responses texts related to critical process failure and may be labeled as crashes. The data clusters 602 may be utilized for automated filtering and/or quickly initializing a labeling training set for domain experts.

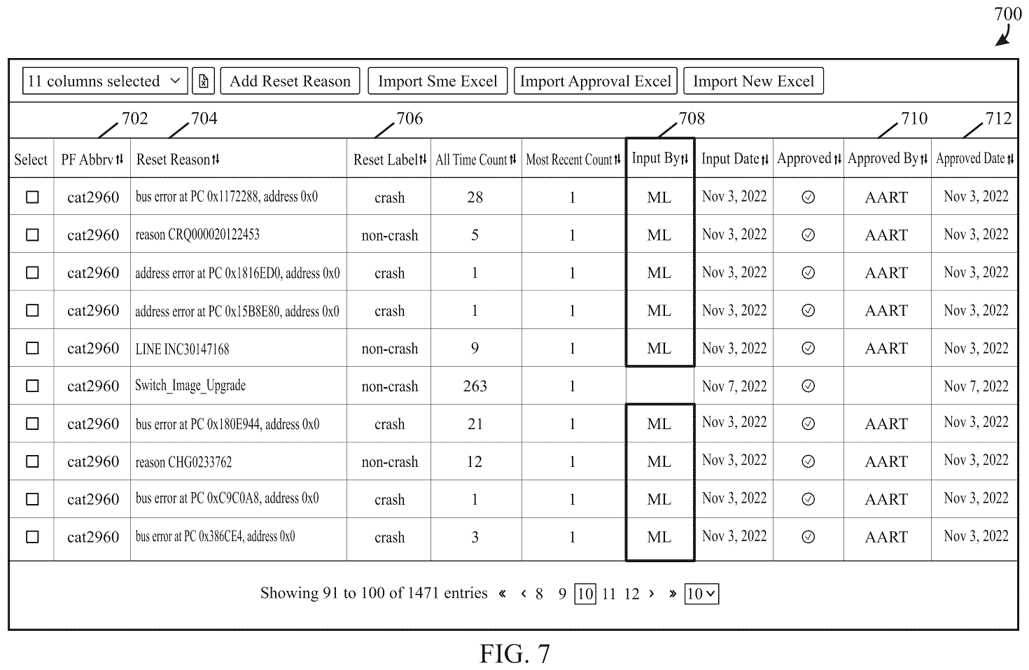

FIG. 7 illustrates an example of an automated labeling output 700 from a data labeling and training pipeline (such as data labeling training pipeline 500 of FIG. 5), in accordance with one or more implementations described herein. Automated labeling output 700 may include an automated labeling of the input telemetry data with the reasons for the device reset.

In various implementations, automated labeling output 700 may include labels attributed to the telemetry data via the labeling operations. For example, the automated labeling output may include an indication of a device type, model, name, or other designation (e.g., PF abbreviation 702). The automated labeling output 700 may also include an indication of a reset reason including diagnostic terms, technical terms, references to memory addresses and/or error codes, etc. (e.g., reset reason 704).

Further, the automated labeling output 700 may also include an indication of a reset label 706 categorizing the reset reason with labels such as “crash” or “not crash” that may help categorize the severity or type of the event leading to the reset. Furthermore, the automated labeling output 700 may also include an indication of an all-time count and/or most recent count of the total number of occurrences of each reset reason over time.

The automated labeling output 700 may include an indication of how the reset reason was identified. For example, it may include an indication whether the reset reason was identified manually or by machine learning (e.g., ‘input by’ data 708). In addition, the automated labeling output 700 may include an indication 710 of who approved a reset reason and/or when that approval was issued (e.g., approved by date 712).

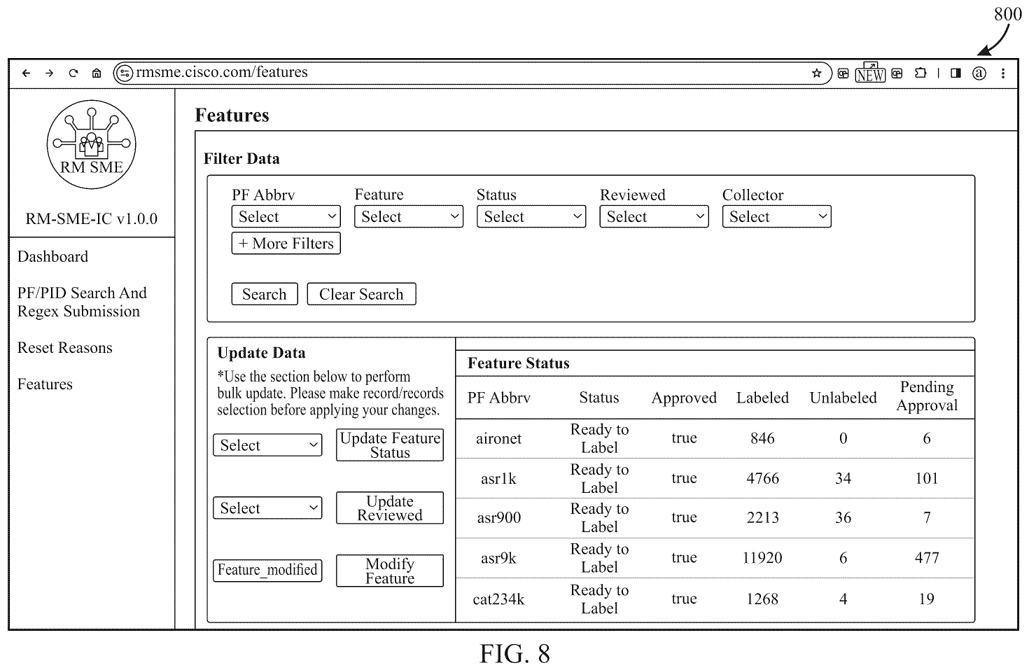

FIG. 8 illustrates an example of a labeling review interface 800, in accordance with one or more implementations described herein. The labeling review interface 800 may be a feature management user interface that is configured to be utilized by a network expert to review and label the telemetry data. This interface may be part of a system designed to manage and track the labeling of telemetry data for a machine learning or AI utility. The automatically labeled telemetry data (e.g., a portion of automated labeling output 700 of FIG. 7) may be presented via labeling review interface 800. The user may utilize this data in reviewing and/or updating telemetry data labels and/or feature statuses. The interface may allow users to filter and search for specific features using several criteria, update data including through bulk updates to feature statuses, and review the status of different features.

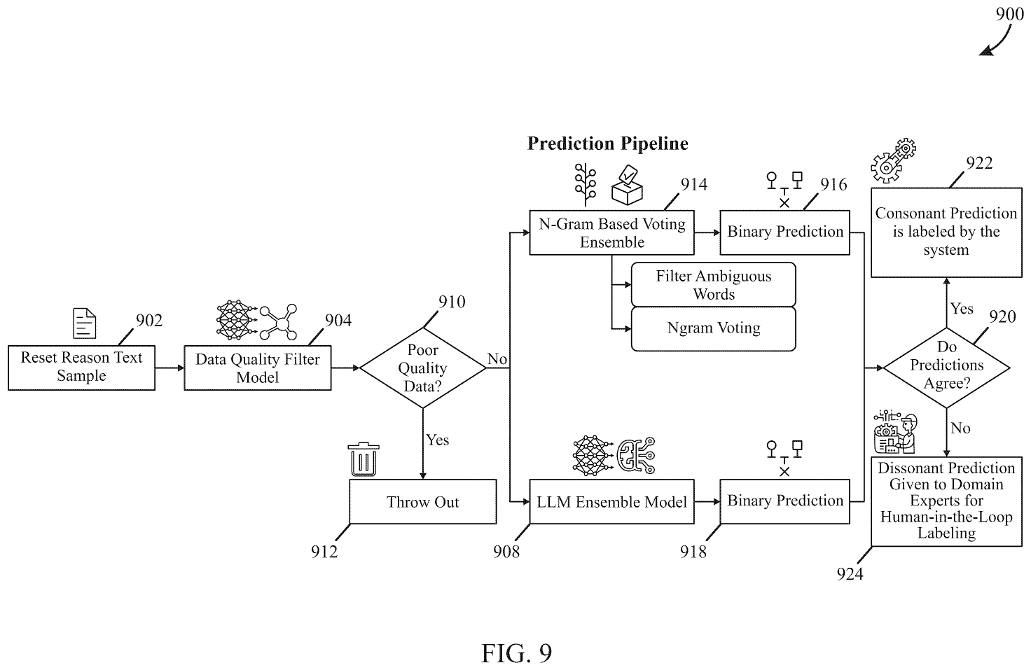

FIG. 9 illustrates and example of a prediction pipeline 900 for multi-language model-based filtering and labeling of datasets, in accordance with one or more implementations described herein. Prediction pipeline 900 may obtain telemetry log data 902 from networked devices. The telemetry log data 902 may include reset reason text from the devices.

A data quality filter 904 may be applied to the telemetry log data 902. A data quality determination 910 may be made about the telemetry log data 902 and poor-quality data (e.g., unusable data, incorrect data, non-relevant data, corrupted or non-sensical data, data below a data quality threshold, data clustered in a garbage data cluster, etc.) may be discarded 912.

The remaining pre-processed data may be fed into an ensemble model 908. The ensemble model 908 may be utilized to generate a binary prediction 918. The binary prediction 918 may be a prediction of a classification of a reset, a reset reason, a cause of a reset, etc. For example, the binary prediction 918 may be a prediction of “crash” or “non crash. ”

In addition, the remaining pre-processed telemetry data may be fed into an N-gram based voting ensemble 914. The N-gram based voting ensemble 914 may include multiple models or predictions that are evaluated based on their coherence with surrounding N-grams. As would be appreciated, N-gram language models generally operate by predicting upcoming words, based on the prior n-number of words, also referred to as the N-gram. Here, the N-gram based voting ensemble 914 may filter ambiguous words from the pre-processed telemetry data, checking for ambiguous or conflicting terms in the text of the data, and the like. Ambiguous words may be corrected or filtered out to ensure clarity and accuracy.

Then, N-gram based voting ensemble 914 may employ N-gram voting, evaluating words to resolve ambiguities and ensure coherence between words based on their context. The voting may include a confidence-based vote for candidates that form the most probable N-gram sequence based on coherence with the surrounding context. Candidates with the highest number of votes may be selected to formulate the N-gram binary prediction 916, much like the binary prediction 918 from the ensemble model 908.

An agreement comparison 920 may be performed between the N-gram binary prediction 916 and the binary prediction 918 from the ensemble model 908. If the predictions from both models agree (e.g., they both produce the same result), the prediction may be labeled 922 automatically by the system as a consonant prediction (e.g., both models are in harmony). Alternatively, if the predictions do not agree (e.g., they are dissonant), the telemetry data may be flagged for review and passed on to domain experts for human-in-the-loop labeling 924. This may introduce human experts into the process to intervene and resolve the discrepancy and provide a final label (e.g., via a user interface), ensuring the accuracy of the final label.

The output of prediction pipeline 900 (e.g., labeled telemetry data from network devices such as labels for the reasons the devices reset) may be leveraged in a predictive maintenance system for network devices, machinery, or any complex infrastructure that generates telemetry event logs. Such a predictive maintenance system may use data analytics, machine learning, and historical patterns to predict when equipment might fail or require maintenance, allowing preventative action before a breakdown occurs.

For example, a network infrastructure where thousands of entities such as routers, switches, firewalls, and the like are running may generate large volumes of telemetry data. Each device may continuously generate logs related to its performance. A predictive maintenance system may leverage the output of prediction pipeline 900 to detect minor anomalies the indicate a device is about to fail, use an LLM ensemble to correlate these anomalies with historical failures to predict which devices are at risk of failing, automatically flag these devices for maintenance and generate alerts for the IT team, and over time, as the system learns from feedback it may become better at predicting failures with fewer false alarms. As such, the predictive maintenance system may leverage the data from the prediction pipeline 900 to automate early warning, minimize downtime, and ensure efficient use of maintenance resources.

Overall, the prediction pipeline 900 increases the accuracy and reliability of the labeling system as well as models relying on those labels. Multiple models may be used to cross-check predictions and introduce human review only where necessary. This automated framework may ensure label accuracy and minimal human intervention. The end-to-end process within prediction pipeline 900 guarantees minimal use of human resources for redundant labeling tasks by automating the labeling process with a series of data quality checks. In various implementations, this may relieve a substantial portion of human resources (e.g., by eight nine percent).

Prediction pipeline 900 may achieve the reliable labeling necessary to reduce human intervention by leveraging the ensemble of language models and a N-gram-based voting methodologies to highlight dissonant/consonant predictions when creating labeled data for predictive maintenance. Past labeling may then become the human feedback reinforcement learning HFRL for future models.

Further, prediction pipeline 900 may automatically excluding ambiguous text for human-in-the-loop labeling when it is necessary. The data exclusion method implemented in prediction pipeline 900 may verify consonant label predictions at one hundred percent accuracy (with no human intervention needed) while leaving dissonant predictions for human-in-the-loop intervention.

Prediction pipeline 900 may also achieve consistent high quality data inputs using a high/low quality data detector and/or filter method to detect high/low quality data for labeling based on a large language model and clustering techniques. Prediction pipeline 900 may include automated data quality filter creation as well.

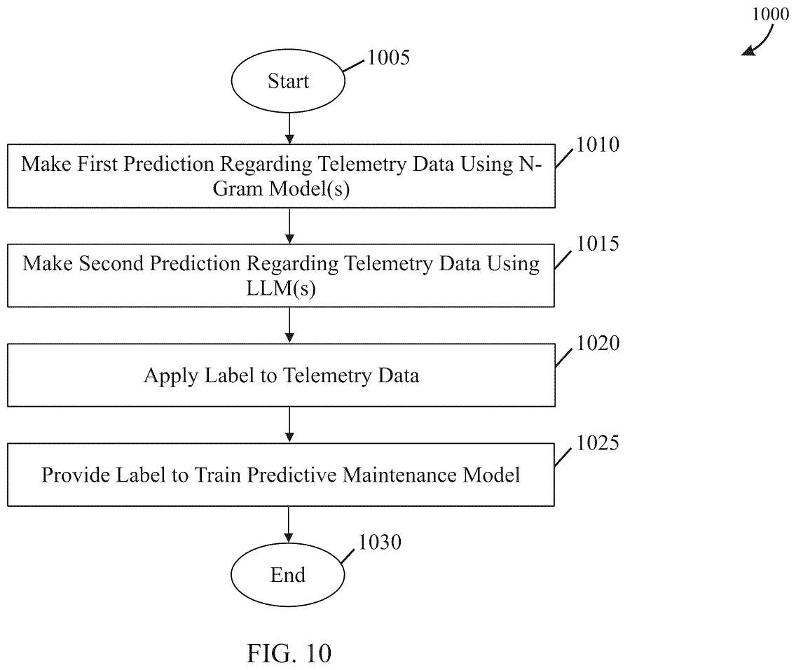

FIG. 10 illustrates an example procedure 1000 (e.g., a method) for multi-language model-based filtering and labeling of datasets, in accordance with one or more implementations described herein. For example, a non-generic, specifically configured device (e.g., device 200, such as a router), may perform procedure 1000 (e.g., a method) by executing stored instructions (e.g., labeling process 248). The procedure 1000 may start at step 1005, and continues to step 1010, where, as described in greater detail above, the device (e.g., a controller, processor, etc.) may make a first prediction regarding telemetry data from an entity in a computer network using one or more N-gram models. In various implementations, the entity is a router, switch, or firewall. In some implementations, the one or more N-gram models comprise an ensemble of voting N-gram models. In one implementation, the device may apply also a data quality filter to the telemetry data, prior to making the first prediction and the second prediction. In such a case, the data quality filter may remove event information from the telemetry data that lacks a corresponding reason.

At step 1015, as detailed above, the device may make a second prediction regarding the telemetry data using one or more large language models. In various implementations, the one or more large language models comprises an ensemble of large language models.

At step 1020, the device may apply a label to the telemetry data based on the first prediction and on the second prediction, as described in greater detail above. In some cases, this may entail prompting, by the device and via a user interface, a user to label the telemetry data, when the first prediction and the second prediction do not agree.

At step 1025, as detailed above, the device may provide the label to train a predictive maintenance model for the entity in the computer network. In one implementation, the label indicates whether a reset event encountered by the entity was a crash. In various implementations, the device may also train the predictive maintenance model using the label and the telemetry data and deploy the predictive maintenance model to monitor the entity in the computer network. The device may also provide an indication of the label to a user interface.

Procedure 1000 then ends at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

It should be noted that while certain steps and/or components within the labeling and prediction pipelines may be optional as described above, the steps and/or components shown are merely examples for illustration, and certain other steps and/or components may be included or excluded as desired. Further, while a particular order of the steps and/or components is shown, this ordering is merely illustrative, and any suitable arrangement of the steps may be utilized without departing from the scope of the implementations herein.

The techniques described herein, therefore, introduce a mechanism for enhancing the efficiency and accuracy of a data labeling process, particularly for complex datasets such as telemetry and device reset logs. By leveraging a combination of diverse language models in an ensemble, the system enhances the extraction of meaningful information from raw data while reducing dependency on manual intervention.

For example, through automated clustering and filtering of data based on embeddings irrelevant or malformed data points are effectively discarded, ensuring that only high-quality data contributes to the final labeled data set. This process can not only accelerate data preparation for model training but also mitigates common issues like human error, infrequent labeling, and inconsistencies due to the availability of domain experts. These techniques can be applied across various use cases, from enhancing predictive maintenance in networked devices to enhancing the reliability of AI-driven diagnostic tools.

While there have been shown and described illustrative implementations that provide for multi-language model-based filtering and labeling of datasets, it is to be understood that various other adaptations and modifications may be made within the spirit and scope of the implementations herein. For example, while certain implementations are described herein with respect to using certain elements, modules, components, architectures, etc. for the purposes of multi-language model-based filtering and labeling of datasets, the elements, modules, components, architectures, etc. are not limited as such and may be used for other functions, in other arrangements, in other functional distributions, in other implementations, etc.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
making, by a device, a first prediction regarding telemetry data from an entity in a computer network using one or more N-gram models;
making, by the device, a second prediction regarding the telemetry data using one or more large language models;
applying, by the device, a label to the telemetry data based on the first prediction and on the second prediction; and
providing, by the device, the label to train a predictive maintenance model for the entity in the computer network.

2. The method as in claim 1, wherein the entity is a router, switch, or firewall.

3. The method as in claim 1, wherein the one or more N-gram models comprise an ensemble of voting N-gram models.

4. The method as in claim 1, wherein the one or more large language models comprises an ensemble of large language models.

5. The method as in claim 1, wherein applying the label to the telemetry data based on the first prediction and on the second prediction comprises:
prompting, by the device and via a user interface, a user to label the telemetry data, when the first prediction and the second prediction do not agree.

6. The method as in claim 1, wherein the label indicates whether a reset event encountered by the entity was a crash.

7. The method as in claim 1, further comprising:
applying, by the device, a data quality filter to the telemetry data, prior to making the first prediction and the second prediction.

8. The method as in claim 7, wherein the data quality filter removes event information from the telemetry data that lacks a corresponding reason.

9. The method as in claim 1, further comprising:
training, by the device, the predictive maintenance model using the label and the telemetry data; and
deploying, by the device, the predictive maintenance model to monitor the entity in the computer network.

10. The method as in claim 1, further comprising:
providing, by the device, an indication of the label to a user interface.

11. An apparatus, comprising:
one or more network interfaces;
a processor coupled to the one or more network interfaces and configured to execute one or more processes; and
a memory configured to store a process that is executable by the processor, the process when executed configured to:
make a first prediction regarding telemetry data from an entity in a computer network using one or more N-gram models;
make a second prediction regarding the telemetry data using one or more large language models;
apply a label to the telemetry data based on the first prediction and on the second prediction; and
provide the label to train a predictive maintenance model for the entity in the computer network.

12. The apparatus as in claim 11, wherein the entity is a router, switch, or firewall.

13. The apparatus as in claim 11, wherein the one or more N-gram models comprise an ensemble of voting N-gram models.

14. The apparatus as in claim 11, wherein the one or more large language models comprises an ensemble of large language models.

15. The apparatus as in claim 11, wherein the apparatus applies the label to the telemetry data based on the first prediction and on the second prediction by:
prompting, via a user interface, a user to label the telemetry data, when the first prediction and the second prediction do not agree.

16. The apparatus as in claim 11, wherein the label indicates whether a reset event encountered by the entity was a crash.

17. The apparatus as in claim 11, wherein the process when executed is further configured to:
apply a data quality filter to the telemetry data, prior to making the first prediction and the second prediction.

18. The apparatus as in claim 17, wherein the data quality filter removes event information from the telemetry data that lacks a corresponding reason.

19. The apparatus as in claim 11, wherein the process when executed is further configured to:
train the predictive maintenance model using the label and the telemetry data; and
deploy the predictive maintenance model to monitor the entity in the computer network.

20. A tangible, non-transitory, computer-readable medium storing program instructions that cause a device to execute a process comprising:
making, by the device, a first prediction regarding telemetry data from an entity in a computer network using one or more N-gram models;
making, by the device, a second prediction regarding the telemetry data using one or more large language models;
applying, by the device, a label to the telemetry data based on the first prediction and on the second prediction; and
providing, by the device, the label to train a predictive maintenance model for the entity in the computer network.
